(19) United States
(12) Patent Application Publication
(10) Pub. No.: US 2004/0148272 A1
(43) Pub. Date: Jul. 29, 2004

(54) Logical pathname as a reference mechanism for data

(76) Inventors: Balan Sethu Raman, Redmond, WA (US); Rajeev B. Rajan, Kirkland, WA (US); Sameet Harishanker Agarwal, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/353,545

(22) Filed: Jan. 29, 2003

(51) Int. Cl. G06F 17/30; G06F 7/00

(52) U.S. Cl. 707/1

(57) ABSTRACT

An object stored in a database can be accessed with the same set of application programming interfaces used to access a file in a file system by accessing the object by logical pathname. A mechanism for obtaining a logical pathname to the BLOB (stored natively or as a filestream) stored as a cell in a table is provided. The pathname may be used to open a handle to the file.

### FIELD OF THE INVENTION

This invention relates to the field of database management systems, and in particular to the field of storage and retrieval of large unstructured data items.

### BACKGROUND OF THE INVENTION

In recent times there has been an explosion of large unstructured data types such as pictures, videos and movies, with an accompanying need to store these large streams of data in an efficient manner. Traditionally, data has been stored in a construct such as a file system or in a database.

The file system is a hierarchical structure of data in which files are stored within folders on a storage medium such as a hard disk. A part of the operating system maintains the file system and controls access to the files in the file system. File systems are good at streaming large quantities of unstructured data in and out of files. One of the problems with the file system as it is presently known, is that files must be manually organized into groups (folders and sub-folders) and if the user forgets where he has stored a particular file, it may be difficult to find the file again. This problem is exacerbated by technology drivers such as advances in disk technology which have seen the development of larger and larger hard disks. The sheer volume of data capable of storage on a single disk can make keeping track of files in a file system a gargantuan task.

The other widely used method of data organization is the database. A database system stores data as one or more tables in which each row of the table comprises groups of related data elements concerning an entity and columns in the table represent useful pieces of information about the entity that is the subject of the row. For example, a database of human resources information may be maintained in which each row of the human resources database represents an employee and each column in the human resources database represents data elements such as employee name, employee social security number and employee pay rate.

Databases provide a number of useful advantages over the file system organization of data. Database management systems are good at storing, finding, and retrieving small pieces of structured data. Typically, in addition, there are highly flexible means of searching for and accessing specified portions of the data stored in the database. Heretofore, however, databases have not handled the storage and access of large pieces of unstructured data, referred to as BLOBs (binary large objects), particularly well.

Specifically, when a database includes a BLOB column, typically the BLOB is torn apart into small pieces which are scattered across the disk. The entry in the database column contains a pointer to the first of the pieces of the BLOB rather than containing the data itself. This situation leads to inefficiencies in retrieving the data in the BLOB because in order to retrieve the data in the BLOB, the different pieces must be found and reassembled. To reduce the impact of these inefficiencies, typically instead of instantly retrieving the BLOB, a pointer to the first piece of the BLOB would be returned instead of the BLOB itself.

For example, suppose a database of employee information includes a BLOB column for employee photograph. Suppose a user requests a particular employee photograph, and is returned a pointer to the photograph. The pointer represents a physical location—e.g., a 16-byte hexadecimal value representing the actual disk address of the sector of the disk where the first piece of the photograph is stored. Several problems can arise. In addition to the disk address being unintelligible to the user, if the operating system reorganizes the data on the disk, the photograph may no longer exist at that location, in which case, a “not found” message will be returned to the user.

Recently, another way to store BLOBs has been developed, as described in U.S. Patent Application entitled, “Filestream Data Storage Attribute”, filed on even date herewith, and incorporated herein by reference in its entirety. A BLOB is stored as a contiguous file or filestream in the file system. A “filestream” data storage attribute is provided that can be used to tag a column in a relational table. The filestream attribute indicates that the data for that column will be stored as a file in the file system in the operating system (OS). The database management system manages the creation and deletion of the file in the file system. There is a 1:1 reference between the file in the file system and a cell (intersection of row and column). The data in the filestream column can be manipulated the same way as the data in other columns using a programming language, such as SQL or MICROSOFT®'s T-SQL.

Thus, a BLOB column is used in SQL for large unstructured data. This was stored using native database formats as non-contiguous chunks of data. With the invention of the filestream data storage attribute, as noted above, it can be stored as a contiguous file in the file system. Whether a BLOB is stored using native database formats or as a filestream, there is a need for a logical reference to the BLOB that is invariant in the face of physical reorganizations of the data. There is a need to refer to the location of the BLOB, whether stored as a filestream or not, by means of a logical reference so that the location returned to the user would have meaning to the user, and furthermore, would not be affected by changes at the physical level.

In view of the foregoing, there is a need for systems and methods that overcome the limitations and drawbacks of the prior art.

### SUMMARY OF THE INVENTION

An object stored in a database can be accessed with the same set of application programming interfaces used to access a file in a file system by accessing the object by a logical pathname. A mechanism for obtaining a logical pathname to the file or filestream stored as a cell in a table is provided. The pathname may be used to open a handle to the file. Access to the file is controlled by security associated with the database management system used to create the database.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is an exemplary computing environment in which aspects of the present invention may be implemented;

FIG. 2 is a block diagram illustrating an exemplary computing environment in which a client accesses a database in accordance with the present invention;

FIG. 3 is a block diagram illustrating an exemplary database in which a column of a database table contains a reference to a BLOB that is stored as a non-contiguous file in a file system in accordance with the present invention;

FIG. 4 is a block diagram illustrating an exemplary database in which a column of a database table contains a reference to a filestream that is stored as a contiguous file in a file system in accordance with the present invention;

FIG. 5 is a block diagram illustrating an exemplary security model of accessing a BLOB (native or filestream) using a logical pathname in accordance with the present invention; and

FIG. 6 is a flow diagram of an exemplary method for accessing a large object of a cell of a database stored as a file in a file system by a logical pathname in accordance with the present invention.

### DETAILED DESCRIPTION OF PREFERRED EMBODIMENTS

Exemplary Computing Environment

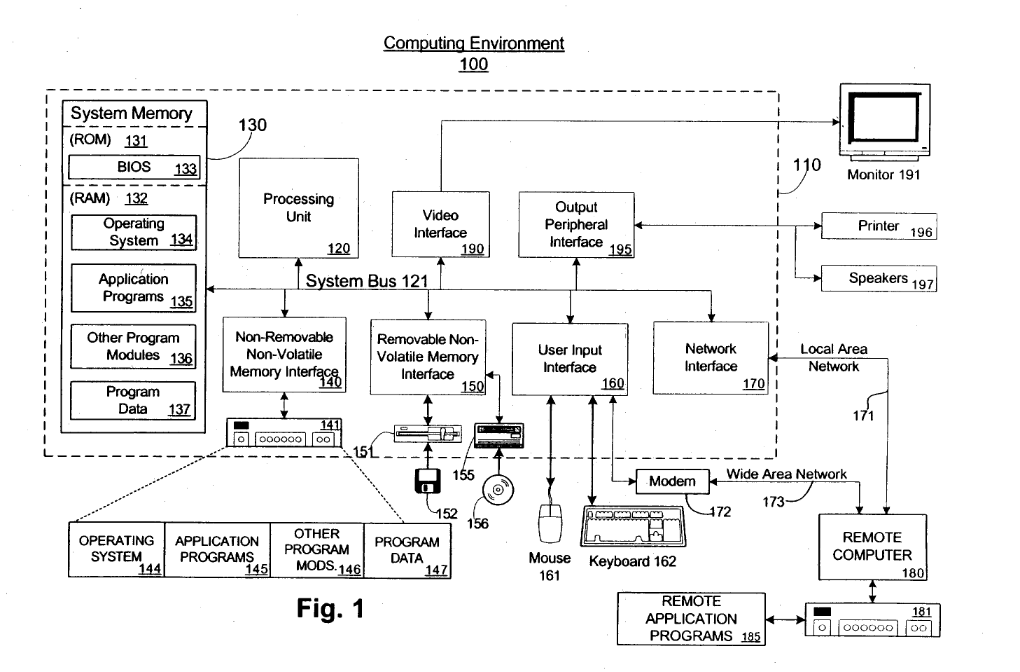

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and web-enabled interface for applications and computing devices, making computing activities increasingly web browser or network-oriented.

For example, MICROSOFT®'s .NET platform includes servers, building-block services, such as web-based data storage, and downloadable device software. Generally speaking, the .NET platform provides (1) the ability to make the entire range of computing devices work together and to have user information automatically updated and synchronized on all of them, (2) increased interactive capability for web sites, enabled by greater use of XML rather than HTML, (3) online services that feature customized access and delivery of products and services to the user from a central starting point for the management of various applications, such as e-mail, for example, or software, such as Office .NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While exemplary embodiments herein are described in connection with software residing on a computing device, one or more portions of the invention may also be implemented via an operating system, API, or a “middle man” object between a coprocessor and requesting object, such that services may be performed by, supported in, or accessed via all of .NET's languages and services, and in other distributed computing frameworks as well.

Exemplary Embodiments

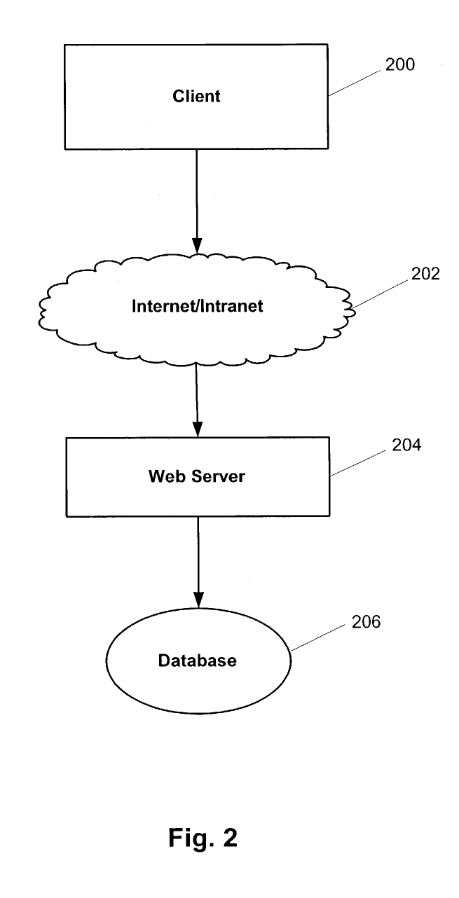

FIG. 2 is a diagram of an exemplary system in which aspects of the present invention may be practiced. A client 200 is connected via a network 202, such as the Internet, an intranet or other suitable network, to a web server 204. A client 200 may query a database 206 via the web server 204. It will be understood that FIG. 2 is exemplary only. For instance, client 200 may directly access database 206, and so on.

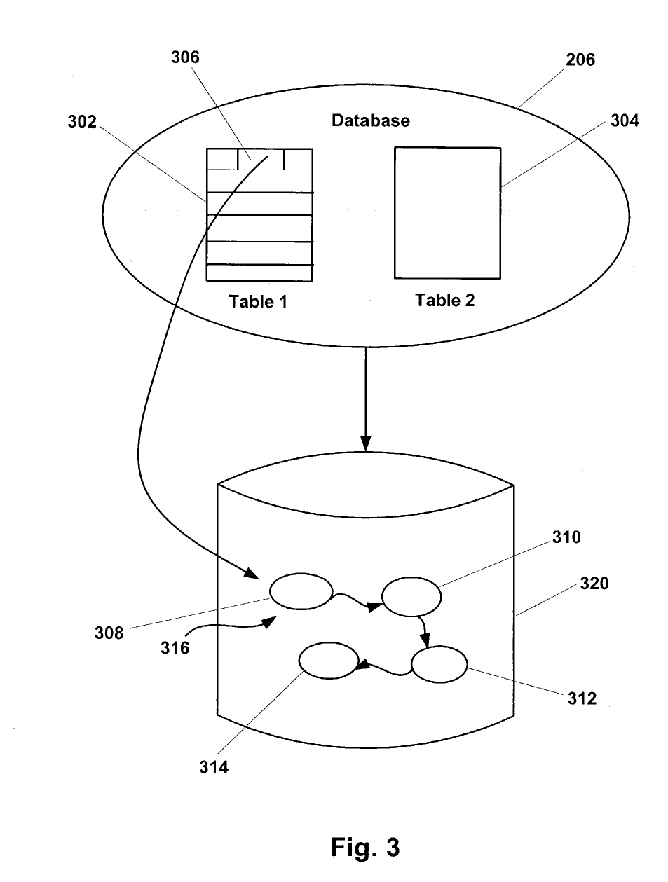

FIG. 3 is a block diagram of a database 206 comprising table 1 302 and table 2 304. Table 1 302 may include a column 306 that contains a pointer to a non-contiguous BLOB 316. The non-contiguous BLOB 316 pointed to by pointer 306 may be represented as BLOB pieces 308, 310, 312, and 314 on storage medium 320. As used herein, it is noted that there are two kinds of BLOBs. The first type of BLOB is “native” in which the BLOB is stored using native database formats and therefore, is stored as non-contiguous files. The second type of BLOB is “filestream” in which the BLOB is stored as contiguous files.

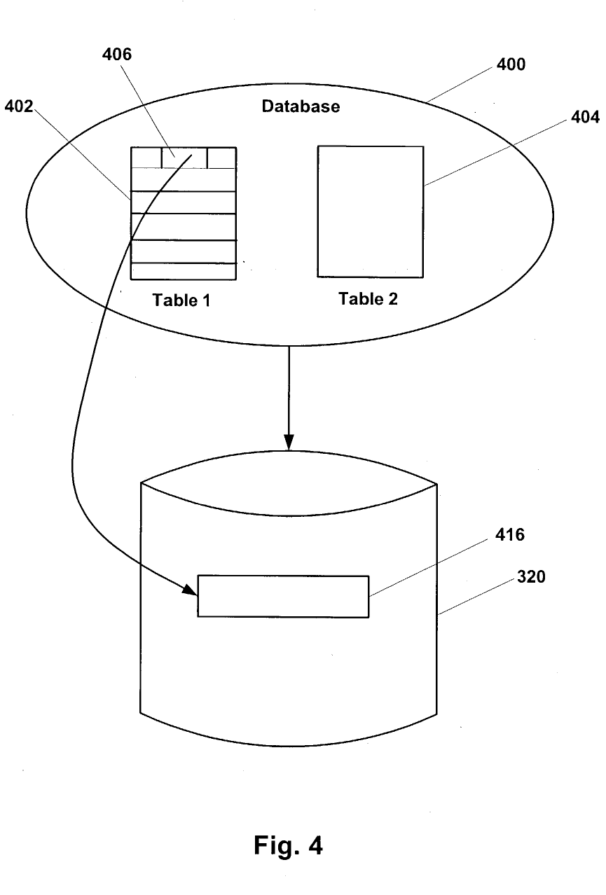

FIG. 4 is a block diagram of a database 400 comprising table 1 402 and table 2 404. Table 1 402 may include a column 406 that contains a pointer to a contiguous file 416 (e.g., a filestream, as discussed in co-pending Application entitled, “Filestream Data Storage Attribute”, filed on even date herewith, and incorporated herein by reference in its entirety). In this case, the file 416 pointed to by column 406 is a contiguous file stored on storage medium 320.

In order to manipulate the non-contiguous BLOB 316 or the contiguous file (e.g., filestream) 416, an application programming interface (API), such as but not limited to Win32, may use a pathname to access the non-contiguous BLOB 316 or the contiguous file 416. The pathname used may adhere to standards used in the industry. One such standard is a universal naming convention (UNC) pathname. In accordance with the present invention, a mechanism for obtaining a pathname to a BLOB (native or filestream) stored as a cell in a database table is disclosed. In an embodiment of the present invention, the pathname obtained is a UNC pathname, although the use of other naming conventions is contemplated by the invention. The pathname can be used by the API module that creates files to obtain a handle. Subsequent processing may be performed using the handle. The pathname is preferably logical with respect to the position of the cell in the database.

For example, an instance of a database management system such as but not limited to SQL Server can include a number of databases, such as those described above with respect to FIGS. 3 and 4. Such a database, as discussed above, may include a number of tables. A table can include a number of columns declared within the table definition and a number of rows may exist within the table, based on the amount of data in the table (e.g., the number of “records” in the database). The intersection of a row and a column is referred to herein as a cell. For instance, a human resources database at a particular company might have an employees table as follows:

| | | |
|---|---|---|
| Table Employees ( | | |
| Unique Identifier | Id | //Employee Id is a unique Id |
| | | (ROWGUIDCOL) |
| String | Name | //Employee Name is a string |
| String | SSN | //Employee SSN is a string |
| Int | Salary | //Employee Salary is an integer |
| Filestream | Photograph | //Employee photograph is a filestream |

(i.e., a contiguous file in a file system)

The table Employees, for instance, may be stored in a database, HRD, on a SQL Server, HRSQL. The filestream in this table may be stored in a filegroup called EmpPhotos, for example, which may have a container called PhotosContainer. In the example given, the logical pathname of a filestream cell with Id=Id1 may be:

\\HRSQL\HRD\EmpPhotos\PhotosContainer\Employees\Photograph\Id1

The components in the pathname are items derived from the database table and the data elements contained in the database and the way the user has organized the data in the table. Therefore, the user is likely to be able to relate to the pathname. It will be noted that the components of the pathname are logical elements that describe the position of the filestream cell in the Employees table. Thus, in general, the pathname composition may be as follows:

\\<DBMSServerName>\<DatabaseName>\<Filegroup>\<Container>\<Table>\<Column>\<ROWGUIDCOL>

The <Container> portion of the pathname is optional, and preferably used when containers are present. It will be noted that although in the example, a filestream is used, the invention is not so limited—e.g., a BLOB may as easily be used. If the filestream value exists in the table, a file system API open using this pathname will be likely to succeed if the user has access to the value using the database security model. A file system API open is also likely to succeed even if the physical location of the filestream changes because the pathname is independent of the physical location of the filestream. If the value does not exist, the file system API open is likely to return an error code such as but not limited to: ERROR_PATH_DOES_NOT_EXIST. According to an embodiment, obtaining the pathname does not imply that any server resources are committed to keeping a lock on the value or maintaining the existence of the value.

It will be noted that the filestream may have a physical pathname on the volume that may be different from the logical pathname. During the course of processing the file system API open request, the logical name may be translated into the actual physical name. An application that wants to manipulate BLOBs (native or filestreams), may be provided with a new intrinsic function, called GetPathName( ) in one embodiment of the invention, that can be used to obtain the logical pathname.

An example of a T-SQL query that may be used to do this is “SELECT GetPathName(Photograph)”, although it will be understood that other queries in other query languages are contemplated by the invention. Based on the example above, for example, this command may return a UNC pathname for the Photograph column for the filestreams satisfying a WHERE clause. The returned pathname may be used by a file system API.

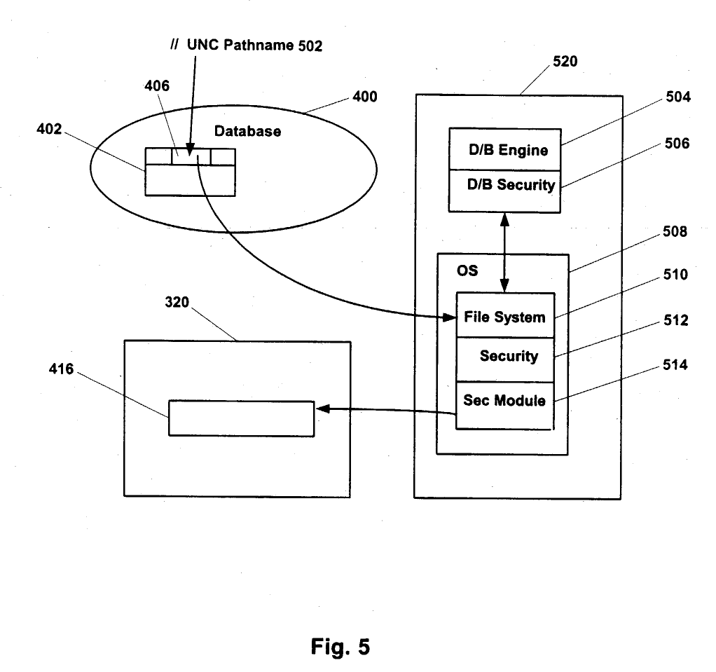

FIG. 5 is a block diagram of a security model for accessing a filestream 416 pointed to by a column 406 in a database 400 and stored as a file 400 in the file system in accordance with the invention. When a logical pathname 502 is obtained and the value of the filestream 416 or BLOB, for example, is then requested, the access that the application or user has to the value depends on the security model invoked by the database engine 504, which includes a database security subsystem 506. File system 510 of operating system 508 includes a file system security subsystem 512; however, access to file 416 is preferably not controlled by file system security subsystem 512, but by database security subsystem 506.

The security model invoked by the database management system engine 504 is governed by a database security user interface and is a much more flexible system than that of the file system. For example, in a database system, a user Z may be denied access to rows of data or columns of data where the value of the data element corresponds to a particular value. For example, Z may be denied access to a row of the table if the “city” column=“Paris”. Hence, when a logical filename reference is passed to an application (or user), when the application tries to access the reference via file system 510, the database management system database engine 504 is contacted and the database management system tells the file system 510 whether or not that user is allowed access to the requested data. To implement this scenario, in one embodiment of the invention, security settings within the database are registered with the file system 510 and a module 514 (e.g., a database security agent portion of the file system 510) is invoked whenever the file system 510 is called.

Depending on the settings in the database system, if the user has access, a handle is returned. In one embodiment of the invention, an agent 514 sits on top of the file system 510 and brokers access to the item, which can be either a filestream 416 (as depicted in FIG. 5) or a BLOB, for example.

Within a database, typically there is a data element that uniquely identifies a row. Suppose a row in a Human Resources employee table is uniquely identified by social security number (SSN). Social security number, in addition to uniquely identifying the row, may also be a primary key, or, alternatively, a primary key may be comprised of several data elements such as last name and first name. In an embodiment of the invention, the primary key (suppose it is social security number) would comprise part of the logical pathname. That is, to return employee “Bob”'s photograph, the last portion of the logical pathname may be Bob's social security number.

In another embodiment of the invention, because it may not be desirable to have Bob's social security number returned, and because it may be difficult to determine what could comprise sensitive data, a hidden column is created. The hidden column represents a unique identification code that is generated specifically to be able to access the BLOB or filestream data for a particular row. In this model, a security hole is avoided. Moreover, the unique generated identifier is not data that the user was involved in generating so that this part of the logical path name reference may not be meaningful to the user.

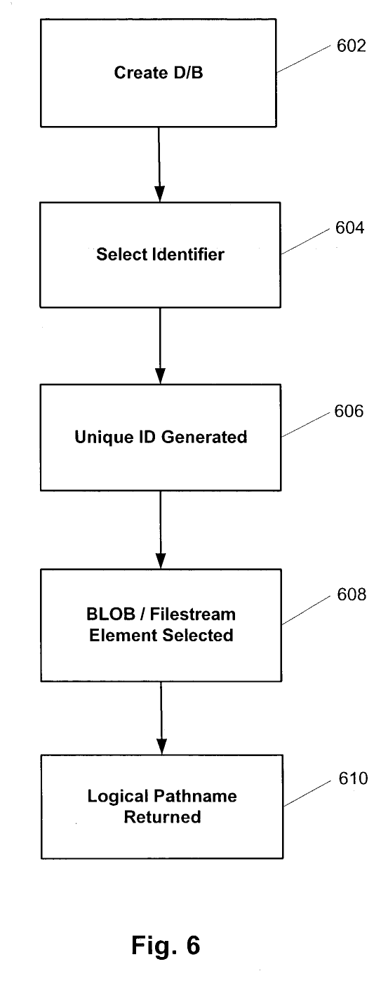

FIG. 6 is a flow diagram of an exemplary method for accessing a large object of a cell of a database stored as a file in a file system by a logical pathname. In an exemplary embodiment, as shown in FIG. 6, at step 602, a database is defined. If the database is to contain a column for a BLOB or filestream, the database builder desirably selects a column of type globally unique identifier (GUID) at step 604. In this embodiment, upon selection of a GUID column, the database engine generates a unique identifier for the row at step 606. An index is then created on the created column. One or more tables comprising the database may be set up, and any number of columns representing data elements of interest may be defined. At step 608, a particular BLOB or filestream is selected via a query SELECT statement. At step 610, a logical pathname is returned. The logical pathname may be used by file system APIs.

The present invention can be applied to a wide variety of technologies, database mapping, resources and localization, web services, business process modeling, enterprise software customization, and tools, for example.

As mentioned above, while exemplary embodiments of the present invention have been described in connection with various computing devices and network architectures, the underlying concepts may be applied to any computing device or system. While exemplary programming languages, names and examples are chosen herein as representative of various choices, these languages, names and examples are not intended to be limiting.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. For example, one skilled in the art will recognize that the methods as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A system for accessing a binary large object (BLOB) in a database comprising:
a database management system comprising a database engine and a security subsystem; and
a database administered by the database management system, the database comprising a datatype for storing the BLOB, the BLOB stored natively or as a file in a file system, the BLOB being accessed by a logical pathname.

2. The system of claim 1, wherein the BLOB is contiguous.

3. The system of claim 1, wherein the BLOB is non-contiguous.

4. The system of claim 1, wherein the logical pathname comprises a plurality of user-defined components, the components including a database server name, a database name, a filegroup, a table, a column, and a unique identifier for a row in the database.

5. The system of claim 4, wherein the logical pathname further comprises a container name.

6. The system of claim 1, further comprising a file system agent wherein access to the file stored in the file system is determined by the file system agent that requests authorization from a database security module before returning a response to a request for the file.

7. A method of accessing a binary large object (BLOB) in a database, comprising:
administering a database using a database management system, the database comprising at least one table comprising rows and columns, wherein a datatype comprises an intersection of a row and a column and the datatype contains a pointer to the BLOB, the BLOB stored natively or as a file in a file system;
selecting a unique identifier for the datatype; and
in response to selecting a datatype, providing a logical pathname representing the location of the BLOB.

8. The method of claim 7, wherein the BLOB is contiguous.

9. The method of claim 7, wherein the BLOB is non-contiguous.

10. The method of claim 7, wherein the logical pathname adheres to a universal naming convention standard.

11. The method of claim 7, wherein the logical pathname comprises a database server name, a database name, a table, a column, and a unique identifier for a row in the database.

12. The method of claim 11, wherein the logical pathname further comprises a filegroup.

13. The method of claim 11, wherein the logical pathname further comprises a container name.

14. A computer-readable medium having stored thereon computer-executable instructions for performing a method of accessing a binary large object (BLOB) in a database, comprising:
administering a database using a database management system, the database comprising at least one table comprising rows and columns, wherein a datatype comprises an intersection of a row and a column and the datatype contains a pointer to the BLOB, the BLOB stored natively or as a file in a file system;
selecting a unique identifier for the datatype; and
in response to selecting a datatype, providing a logical pathname representing the location of the BLOB.

15. The computer-readable medium of claim 14, wherein the BLOB is contiguous.

16. The computer-readable medium of claim 14, wherein the BLOB is non-contiguous.

17. The computer-readable medium of claim 14, wherein the logical pathname adheres to a universal naming convention standard.

18. The computer-readable medium of claim 14, wherein the logical pathname comprises a database server name, a database name, a table, a column, and a unique identifier for a row in the database.

19. The computer-readable medium of claim 18, wherein the logical pathname further comprises at least one of a filegroup and a container name.

20. A computer-readable medium having stored thereon a logical pathname used to access a large unstructured object stored as a file in a file system or natively.
